(19) United States
(12) Patent Application Publication
(10) Pub. No.: US 2004/0140989 A1
(43) Pub. Date: Jul. 22, 2004

(54) Content subscription and delivery service

(76) Inventor: John Papageorge, San Francisco, CA (US)

Correspondence Address: DERGOSITS & NOAH LLP, Four Embarcadero Center, Suite 1450, San Francisco, CA, 94111, US

(21) Appl. No.: 10/447,334

(22) Filed: May 28, 2003

Related U.S. Application Data
(60) Provisional application No. 60/384,863, filed on May 28, 2002.

(51) Int. Cl. G09G 5/00

(52) U.S. Cl. 345/700

(57) ABSTRACT

A system and method for providing content subscription and delivery to mobile electronic devices. The user subscribes to a fee-based service that provides live or prerecorded content, such as voice messages from celebrities, to the user's mobile electronic device. In the most basic form of the system, the user pays a subscription fee, then selects an entity of interest. Content is then created by the entity of interest and delivered to the user. In a simple embodiment, a communications network is provided with a content subscription system. A data store is coupled to the communications network for storing content, such a voice messages, text messages, gaming applications or any other formatted content. An access component provides controlled access to the content stored in the data store, for example, upon receipt of a proper authorization code by a subscribed user. Once authorized, the user may select content for delivery to his digital device, such as a cellular telephone, computer or PDA.

### BACKGROUND

Many types of content subscription and delivery systems and methods dictate operation only within a narrow range of services and functionality. However, in many applications, the needs and desires of the content-requiring consumers can vary greatly. By way of one example, in the mobile phone industry, the breadth and novelty of services provided can be a very significant factor in a consumer's decision as to which of the various competing entities from whom he or she will receive service. In many other related content-delivery businesses, similar provision of a wide variety of content and services is intimately tied to the ability of each entity to provide features or functionality that are dynamic, new, novel, and/or associated with specific interests of the end user. Regardless of the type of content or functionality involved, the provision of content and services must be easily effectuated and distributed to ensure the proper demand for the entity's services.

Present systems and methods of delivering content, at best, typically involve a limited item or variety of content (e.g., certain ring tones, only) to be delivered to a set device (e.g., mobile phone). For many users, present methods can be satisfactory. However, for more demanding consumers, present systems and methods of receiving desired content have significant drawbacks.

One problem with many present systems and methods of providing content or content-related services/functionality is that in order to receive the desired content or service, users or clients must subscribe to the provider by inflexible, complex and/or outdated mechanisms. Another problem with such systems or methods is that similar inflexible, complex or outdated mechanism oftentimes apply to the content delivery mechanisms, such as those that even limit the format of the data provided. This presents burdens (e.g., lost subscription services, etc.) to content or service providing entities vis-à-vis users that desire different or dynamic types of service and content

A drawback of present systems and methods of providing content or content-related services/functionality is that they only provide for one way of subscribing to the content or service. This typically requires a user to possess and utilize this single means (e.g., media of communication, etc.) to subscribe to an entity, and leads to lost subscriptions for users who do not subscribe due to inaccessibility of the single existing subscription means. In addition, similarly limited payment options for such content and services oftentimes leads to lost subscriptions and/or lost one-time feature (perk) services.

Another drawback of present systems and methods of providing content or content-related services/functionality is their limited provision of content formats. This can frequently lead to a user failing to subscribe to or receive content, in instances where the format offered is unusable or otherwise unacceptable to the user. This drawback extends to systems and methods that supply only content or branded data (e.g., content associated with a celebrity or other entity of interest, etc.) having a discretely limited variety of options/formats (e.g., voice messages, ringtones, pictures, multimedia files and software, etc.).

Yet another drawback is that present systems and methods of providing content or content-related services/functionality typically do not offer a single point of entry, such as a single sign-on, to authenticate and authorize users, handle billing and track the proper usage of various rights (e.g., intellectual property, etc.) or other associated protocol. Such lack of entry ease-of-access presents a burden to users desiring simplicity, and can inhibit user from subscribing to systems having overly complex portals.

Furthermore, current systems and methods of providing content or content-related services/functionality typically only specify the most basic meta data of the content (e.g., file types), and this data is oftentimes only available in a single manner of delivery. Such limitations present substantial burdens to content-driven (especially young) users and, thus, also to the content/services providing entities desiring their business.

Finally, existing systems do not provide universal interoperability of all existing technologies (e.g., IVL, SMS, MMS, etc.), and as such also fail to entice the maximum quantity of diversified users into the content/service entities' revenue streams.

Therefore, current systems and methods for delivering content, such as any voice-related data, or providing subscription functionality are generally unable to provide the flexibility and performance required to effectively provide the types of dynamic/diverse content desired by users to ensure that the relevant content services are desirable enough.

### SUMMARY

Disclosed is a system and method for content subscription and/or delivery. The system allows a user to subscribe to a service that provides live or prerecorded content to a user for a fee. In a preferred embodiment, the content includes voice messages that are produced by celebrities who periodically create voice content. In another embodiment, a content subscription service system and method are provided. After a user selects an entity of interest, content, such as a voice message, is created by the entity of interest. The user pays a subscription fee, which corresponds to the entity of interest. The content (e.g., voice message, etc.) is then provided to the user.

In one embodiment, a communications network is provided with a content subscription system. A data store is coupled to the communications network for storing content, such a voice messages, text messages, gaming applications or any other formatted content. An access component provides controlled access to the content stored in the data store. Preferably, access is authorized only when the user subscribes to a content delivery service. Once authorized, a user may select content for delivery to his digital device, whether it is a cell phone, computer or PDA.

### BRIEF DESCRIPTION OF THE DRAWINGS

The present invention is illustrated by way of example and not limitation in the figures of the accompanying drawings, in which like references indicates similar elements, and in which:

FIG. 1 illustrates a block diagram of a computer system that provides content subscription and delivery;

FIG. 2 illustrates a block diagram of a computer platform, according to one or more embodiments of the present invention;

FIG. 3 is an illustration of a graphical user interface (“GUI”) showing a subscription service enrollment window, according to another embodiment of the present invention;

FIG. 4 illustrates a block diagram of a content delivery system, according to one embodiment of the present invention;

FIG. 5 is a block diagram illustrating the relationship between subscription services and an exemplary content-delivery GUI, according to an embodiment of the present invention; and

FIG. 6 illustrates a block diagram of a content delivery service, according to embodiments of the present invention.

### DETAILED DESCRIPTION

Interactive Voice Response (IVR) systems are used to connect telephone users with data and information located in computer databases and/or other related storage media. Typical IVR systems are automated, providing the user with the ability access information stored in the databases at any time. Such IVR systems are generally telephony-based and they allow access from wherever the device, such as a cellular telephone or hand-held wireless device (PDA), is located. These IVR systems conventionally use Dual-Tone Multi-Frequency (“DTMF”) signaling to allow the user access the system using a standard telephone keypad. More recent IVR systems have the capability to integrate speech recognition into their environments, providing them the ability to support complex interactive and/or transactional services (such as directory assistance, travel-related and financial services) that are too tedious to effectuate using prior DTMF interfaces by themselves. Such systems can also allow for the users to provide recorded responses to specific queries, in addition to providing the user with some basic functionality pertaining to how the recorded responses are handled. One example of such functionality is the ability to forward a recorded message to another recipient, or group of recipients. However, although current IVR systems can offer such limited speech-based publishing functions, they have not yet been able to provide functionality over and above simple message manipulations that are already provided by voice messaging services.

With respect to the general hardware overview pertaining to the systems, servers and platforms of the present invention, such as the IVR system, aspects of the present invention may be implemented on one or more microcomputer based systems executing software instructions. According to a preferred embodiment of the present invention, several computers connected to a network may execute the software instructions, each of them accessing and manipulating shared data which is transmitted and received over a computer network or standard telephone line.

Regardless of the embodiment, the steps of accessing, downloading, and manipulating the data, as well as other aspects of the present invention, are implemented and controlled by a central processing unit (CPU) in a computer executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention, as will be described below.

The instructions may be loaded into the memory of the computer from a storage device, or from one or more other computer systems over a network connection. For example, a server computer may transmit a sequence of instructions to a client computer in response to a message transmitted to the server over a network by the client. As the client receives the instructions over the network connection, it stores the instructions in memory or on disk. The client may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, this embodiment of the present invention is not limited to any specific combination of hardware circuitry and software, nor to any particular source for the instructions executed by the computer running the software.

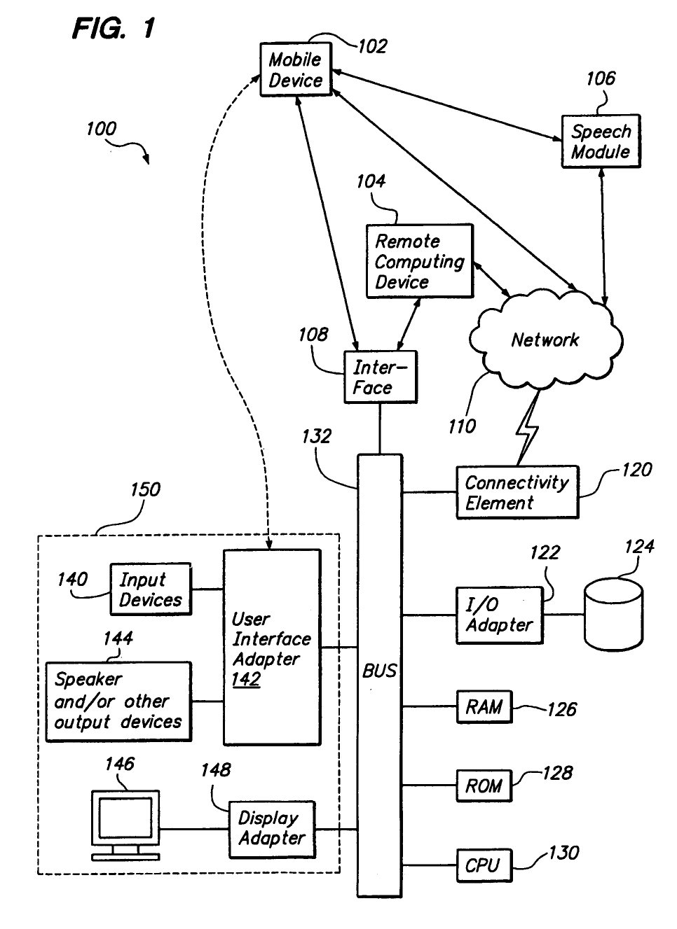

A representative computer system 100 or hardware environment, which implements one or more embodiments of the present invention in association with the systems, servers, etc. detailed elsewhere in this description, is illustrated in FIG. 1. This typical hardware configuration shows, from the prospective of an exemplary workstation, a preferred embodiment including a central processing unit (CPU) 130, such as a conventional microprocessor, and a number of other elements interconnected via a system bus 132.

According to the embodiment of FIG. 1, the computer system 100 is comprised of a client/station 150, a mobile device 102 coupled to a speech module 106, a remote computing device 104, a network 110 coupled inter alia to the aforementioned devices, an optional connectivity element 120 [communication adapter] for connecting the bus 132/workstation to the network 110, an input/output (I/O) adapter for connecting peripheral devices such as storage units 124 to the bus 132, Random Access Memory (RAM) 126, Read Only Memory (ROM) 128, the CPU 130. The connectivity element 120 can include one or more of a variety of devices and/or software routines, and may operate as either a discrete element or via a distributed network of devices and software programs located on/in any of the adjacent elements. In a basic realization, the connectivity element 120 can be a straightforward communications adapter that performs all of the necessary data translations/adaptations associated with typical protocol and data link manipulations. In another embodiment, the connectivity element 120 can be or include an interpreter element used to facilitate and translate between the various media a user may use to subscribe to a content/service entity, and/or providing correct data output for the various content formats required by the users or devices. Such an interpreter can be a simple translator or, again, it may be a complex distributed system that acts as a two-way aggregator and translation mechanism for the full range of data streams set forth herein. In another embodiment, the connectivity element 120 can be or include an access component that manages user subscription routines as well as handling subscriber access functionality. In certain embodiments, such access component advantageously provides a single point of entry, such as a single sign-on, to authenticate and authorize users, handle billing and track the proper usage of various rights (e.g., intellectual property, etc.) or other associated protocols.

The client/station 150 can include a user interface adapter 142 for connecting input devices 140 (e.g., a keyboard, a mouse or other pointing devices/software, a microphone, etc.) and output devices 144 (e.g., a speaker, etc.) associated with a user to the bus 132, and a display adapter 148 for connecting the bus 132 to a display device 146. In the presently preferred embodiment, the workstation 150 typically includes conventional operating system software, such as the Microsoft Windows NT or Windows 2xxx Operating System (OS), the IBM OS/2 operating system, the MAC OS, or UNIX operating system. Those skilled in the art will appreciate that the present invention may also be implemented on platforms and operating systems other than those mentioned.

The communication network 110 (e.g., a data processing network), as shown in FIG. 1, may be outlined as follow. The network interfaces between the network 110, the connectivity element 120 and the devices 102, 104 (and associated speech module 106) may also include one or more routers (not shown) that serve to buffer and route the data transmitted between the system elements. Network 110 can be the Internet, a Wide Area Network (WAN), a Local Area Network (LAN), or any combination thereof. The network 110 is normally a bi-directional digital communications network that connects the various telecommunication elements with the CPU 130. With current technologies, a CATV (cable television) bi-directional network, ISDN (Integrated Services Digital Network), DSL (Digital Subscriber Line), xDSL high-speed network or wireless network are examples of existing network infrastructures enabling the necessary network connections for implementing embodiments of the present invention, though they are not intended to be exclusive as to the types of networks capable of practicing the present invention.

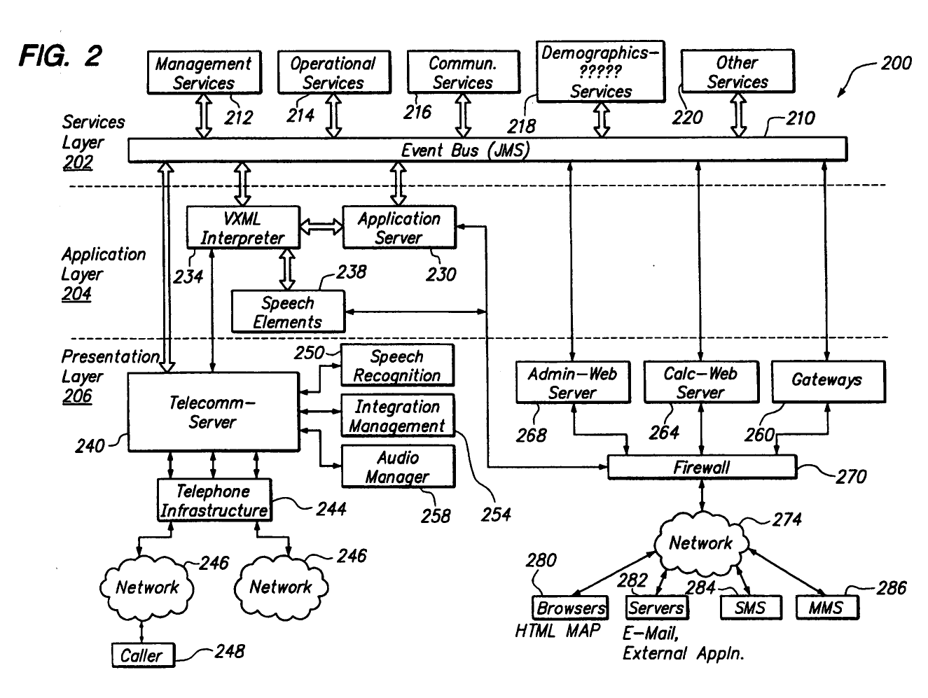

Each relevant computer system 100, server and/or platform (see FIG. 2) of the present invention is configured to be coupled with a multiplicity of clients 150, all of which can operate under various operating systems/protocols. Connectivity can be maintained or provided through the networks addressed above, as well as through means such as TCP/IP, wireless access protocol (WAP), HTTP, an SSL protocol, and/or other protocols. If clients 150, such as remote clients, are to access the computers systems, servers, or platforms through another network, such as the public switched telephone network (PSTN), or a wireless device, then the appropriate protocol is used by the system or server. Connectivity features in the communications stack can be made using SOAP, WML, XML, VXML, and/or HTML programming languages.

The presently preferred embodiment is configured to be coupled to a speech module 106, which is a text-to-speech and speech recognition system. Existing speech module systems, currently best implemented by a VXML 2.0 or higher standard, are exemplified by systems such as those offered by Bevocal, Inc. of Sunnyvale, Calif. The speech module 106 can be hosted on a separate computer system, server or platform, or it can be integrated into the relevant hardware. In the preferred mode of operation, the speech module 106 provides voice- or tone-activated menus for communications from the mobile device user through the system/server/platform via a telephone or wireless device. The speech module 106 can be configured to read text from system files to a listener on the mobile device 102. In a preferred embodiment, the files are drawn from memory locations anywhere in the networked computer system, and they can be in diverse file formats, such as text, RTF, Microsoft Word, Corel, WordPerfect, HTML and other formats. The speech module 106 is also configured to convert dial tone and speech from the mobile device 102 (or, more generally, a user) into HTTP requests, POST or GET, for example, to the system, server, CPU, or other networked element desired. If communication is maintained via a wireless carrier, then any carrier can be used, such as well known GSM or CDMA standards, and/or communications using GPRS, Bluetooth or other standards. Specific realizations and co-embodiments of this basic implementation are set forth with respect to FIGS. 2 to 6, and their associated written description below.

The remote computing device can be a mobile computing unit, such as a portable digital assistant (PDA), a two-way pager or similar device, or it can be a standard desktop or notebook computer. In the presently preferred embodiment, the remote computing device 104 includes conventional means to interface with the World Wide Web, and a standard web browser or another connectivity interface between the resident application and data/information implemented in a markup language, such as WML, XML, VXML, HTML, and/or another SGML variant.

An exemplary platform 200, on which preferred embodiments of the present invention may be implemented, is shown in FIG. 2. The illustrated platform 200 is capable of supporting content-delivery applications pertaining to the provision of diverse business services. For example, content such as voice-provision applications can be utilized for internal applications in larger scale employment (e.g., employee productivity, etc.), or they can be adapted for information and/or consumer services, or they may be used for other services.

The exemplary platform 200 of FIG. 2 provides an end-to-end solution that manages a services layer 202 (e.g., information access, etc.), an application layer 204, a presentation layer 206, as well as any number of telecommunication infrastructure elements. With this representative platform, users can provide/receive complex content, such as voice applications, through a suite of customized applications and diverse development tools, as coordinated via application server 230.

Understanding of the application server 230 is best addressed in relation to the overall application layer 204, set forth as follows. The application layer 204 provides a set of reusable application components as well as the software engine for their execution. Through this layer, applications benefit from a reliable, scalable, and high performing operating environment. The application server 230 automatically handles lower level details such as system management, communications, monitoring, scheduling, logging, and load balancing. Some additional features that may be associated with the application layer 204 are set forth as follows.

The preferred application server 230 itself may be comprised of a high performance (e.g., load balanced, failover provisioned, etc.) web/JSP server that hosts the business and presentation software of the various applications. The preferred application server 230 includes ready-to-use applications, as well as reusable application components, and hosts Java servlets and JSPs for custom applications. It is also preferred that the application server 230 provides easy to use tag libraries to access to the platform applications and services.

Along with the application server 230, the application layer 204 also includes a VXML (VoiceXML) interpreter 234 that is fully compliant with the desired VXML specification (e.g., Version 1.0, 2.0, etc.), as well as optional speech elements 238 (e.g., a speech server, speech objects such as Nuance, etc.). According to the preferred embodiment, the VXML interpreter 234 is written in Java and executes the various VoiceXML applications, and may execute applications hosted on either side of the firewall 270. The VXML interpreter may also include extensions for easy access to any of the diverse system services from the services layer 202, and can be integrated with debugging and monitoring tools. Further, the preferred VXML interpreter 234 is also extensible in that it allows installation of custom VoiceXML tag libraries and speech objects. Such speech objects may be accessible via networked speech elements 238, which can include ready-to-use and custom components. For example, one embodiment of the VXML interpreter 234 can incorporate location-relevant SpeechObjects, such as grammars from street address databases.

A preferred embodiment of the VXML interpreter 234 provides access to external browsing devices, allowing for management connection (to establish, maintain, and terminate) to external browsing and/or output devices (including the encapsulation of details pertaining to the communicating with the external device). For maximum reliability, such external connectivity supports both the input and the output of the media/devices of interest. In addition to the reliable delivery of content and notifications, further embodiments of the preferred VXML interpreter 234 provide additional functionality. For example, a tool such as a vocal player can be provided. Such a vocal player greatly assists usability testing by giving developers straightforward access to audio files of actual user interactions with their speech applications, thereby providing invaluable feedback for improving dialogue design.

In a presently preferred embodiment, speech elements 238 include a speech object server that hosts speech objects based components. In this embodiment, such a speech server provides a platform for running Speech Objects based applications, and contains an extensive library of reusable SpeechObjects.

As a result of this application infrastructure, the preferred platform 200 of FIG. 2 is capable of deploying applications in a reliable, scalable manner, and maintaining the system operability through use of various monitoring tools.

Details of the presentation layer 206, as shown in the embodiment of FIG. 2, are set forth next. According to this embodiment, the presentation layer 206 provides the mechanism for communication with the end user. While the application layer 204 manages the application functionality, the presentation layer 206 manipulates and translates the content into a medium that a user or the user's device can understand. The preferred presentation layer 206 enables multi-modal support. As seen in FIG. 2, the exemplary platform 200 is multi-modal in that it facilitates information delivery via various gateways 260 and other mechanisms such as the calculation and administrative web servers 264, 268. For example, these gateways can include but are not limited to voice gateways, Wireless Application Protocol (WAP) gateways, Hypertext Mark-up Language (HTML) gateways, facsimile gateways, electronic-mail gateways, pager/two-way data gateways, Short Message Service (SMS) gateways, and Multimedia Messaging Service (MMS) gateways. Furthermore, as new touch-points evolve, additional modules may be seamlessly integrated into and supported by the presentation layer 206.

According to the preferred embodiment shown in FIG. 2, the telecommunication portion of the platform 200 is composed of modular architecture, enabling “plug-and-play” capabilities. This exemplary platform 200 is extensible in that developers can create their own custom services to extend the platform utility even beyond the features and functionality specified herein. For further versatility, Java-based components are supported that enable reliability, portability, and rapid development. Other web servers (such as the calculation web server 264 and administrative web server 268) support a web-based development environment that provides a comprehensive set of tools and resources which developers may need to create their own innovative speech applications.

A main piece of the telecommunication architecture, according to the embodiment of FIG. 2, is the telecommunication server 240. The telecommunication server 240 provides the interface between the telephony regime, both Voice over Internet Protocol (VoIP) and Public Switched Telephone Network (PSTN), and the applications running on the platform. The telecommunication server 240 also provides the interface to optional elements such as speech recognition 250, an integration management 254, an audio manager, and other components (such as any, known speech-related telephony elements). Through the telecommunication server 240, other third-party application servers can be interfaced (e.g., unified messaging and conferencing servers, etc.). The telecommunication server 240 connects to the telecommunication (telephony) switches and handles phone-related data transfer.

Basic requirements of the preferred telecommunication server 240 include mission critical reliability, a robust collection of operations/maintenance tools, and telephony connectivity via ISDN/T1/E1, SIP and SS7 protocols. In addition, DSP-based telephony boards should be included to offload the host, providing real-time echo cancellation, DTMF and call progress detection, as well as audio compression/decompression.

Speech recognition 250 element(s) perform speech recognition on real time voice streams from (or through) the telecommunication server 240. In this preferred embodiment, these speech recognition 250 elements support expansive vocabulary size, speaker verification, carrier grade reliability and scalability, high accuracy vis-à-vis speaker-independent recognition, and recognition enhancements for wireless and hands free callers. Similarly, preferred functionality also includes support for multiple languages and dynamic grammar support (allowing grammar data and updates to be added during run time). Additionally, a barge-in function is also preferably enabled, allowing users to interrupt voice applications (e.g., if a caller hears “Please select the city from which flight number . . . ,” the recipient can say the name of the city before the speech recognition 250 element(s) finish. The speech recognition 250 element(s) may also provide easy-to-use, reusable speech objects components, such as Nuance.

Various other features can be associated with the telecommunication server 240, such as functionality related to an integration manager 254 and/or an audio manager 258. The audio manager 258 manages platform elements such as prompt servers (responsible for managing and caching pre-recorded data files for a pool of telecommunication servers), text-to-speech servers, and streaming audio data.

The text-to-speech (TTS) servers are responsible for transforming text into audio output when pre-recorded prompts are unavailable, wherein the audio output can then be streamed to callers connected to the telecommunication server 240. Preferably, the TTS server offloads the telecommunication server 240 and allows pools of TTS resources to be shared across one or more other, potentially diverse telecommunication servers. Standard functionality of such TTS servers includes support for known technologies such as SpeechWorks, Speechify and L&H RealSpeak, and highly compatible Application Program Interface (API) for integration of other TTS engines.

A streaming audio server can be associated with the audio manager, enabling static and dynamic audio files to be played to a user (e.g., a caller 248 connected, for example, via a network 246 and intermediary telephony infrastructure 244). For example, a short audio news feed, such as a traffic update, would be handled by the streaming audio server. The streaming audio server of the preferred invention possesses PSTN connectivity and supports known static file formats such as WAV and MP3, as well as dynamic/streaming file formats such as RealAudio, Microsoft Media Player, and others.

With respect to connectivity, the telecommunications server 240 of the preferred embodiment supports standard telephony protocols like ISDN, E & M, WinkStart, and additional E1 variants allow for connectivity to PBX or local central offices. Support for SIP and SS7 (Signaling System 7) is also provided. Data (telephonic) signaling in one preferred embodiment is primarily supported by the overall platform 200 via Session Initiation Protocol (SIP). In such embodiment, the SIP signaling is independent of the audio stream (provided as a G.711 stream, for example). This SIP-enabled network embodiment provides flexible call routing, call forwarding, blind and supervised transfers, location (GPS) services, interoperability with SIP compliant devices (e.g., soft switches), direct connectivity with SIP-enabled networks and carriers, and gateway connection to SS7 as well as standard telephony networks.

Within the presentation layer, the administrative web server 268 serves as the primary interface for customers. According to a preferred embodiment, the administrative web server 268 enables portal management services and provides desired information (such as billing or reporting information). The administrative web server 268 allows users to modify application content (such as advertisements), and perform other functionality relating to the provision, manipulation, administration or improvement of content (including trouble-shooting and fulfillment functionality). In one embodiment, the administrative web server 268 comprises a network website, including backend logic, that is tied to both the services layer 202 and the application layer 204. In such generally accepted embodiment, access to the site is limited to users with a valid user id and password and/or to those coming from a registered IP address. Once they have initiated service, users are presented with a main GUI, from which they can peruse and access the available resources. In sum, the preferred administrative web server 268 provides a development environment that provides all the tools and resources developers need to create their own speech-related applications, such as the specific sub-embodiments set forth below.

Finally, we turn to the details of the services layer 202, as generally depicted in the block diagram of FIG. 2. In the illustrated embodiment, the services layer 202 simplifies the development of content-delivery applications by providing access to modular value-added services. These backend modules deliver a complete set of functionality, and handle low level processing such as error checking. For purposes of assisting the explanation alone, these backend services can be broadly categorized into management services 212, operational services 214, communication services 216, demographics-related services 218, and other services 220. Using the modular design according to this embodiment, developers can create high performing, enterprise applications without the need for complicated programming. It should be noted that, although descriptions of all of these services are set forth below, various platforms practicing the invention do not necessarily need to implement any of these modular services to still be within the ambit of the present invention.

A first group of backend services according to the embodiment of FIG. 2, management services 212, can be considered to include such services as content management services, user profile management services, portal management services, and configuration management services, with the configuration management services component merely providing the various system configuration tasks (e.g., maintaining configuration, etc.) well known in the art.

The content management service component manages content feeds and databases such as weather reports, financial information, and sporting information, and also ensures that content is received and processed appropriately. In a preferred embodiment, content is only provided upon receipt of an authenticated request. In other exemplary behavior, content management services communicate with record-keeping services (logging service, as discussed below) to track content usage for auditing and other (such as record-related) purposes. Exemplary content management services effectuate multiple, redundant content feeds with automatic failover to provide reliable content delivery. The content management component also sends alarms through alarm service, as set forth below.

The user profile services component manages the user database, and can also connect to a third party user database. For example, if customers desire to leverage their own user database, the user profile service will manage the connection to the external user database. Furthermore, requests such as this must be authenticated prior to providing user information.

The portal management component provides a service that maintains information on the configuration of each content (e.g., voice) portal and enables users to manage their portal(s) through an administration web site. In the preferred embodiment, the portals are highly customizable, allowing users to chose from multiple applications, content, and voice-related services.

A second group of backend services according to the embodiment of FIG. 2, operational services 214, can be considered to include such services as performance monitoring services and logging services. The performance monitoring component provides real-time monitoring of the entire system such as number of simultaneous users per customer, number of users in a given application, as well as the time that the system is either up or down. Users, by means of the performance monitoring functionality, are able to determine performance of system at any instance. The logging component logs all events sent over the event bus 210 (e.g., logging the access to financial quotes by a user, logging an application server 230 request for music information from content management services).

A third group of backend services according to the embodiment of FIG. 2, communication services 216, can be considered to include such services as instant messenger services, notification services, and alarm services. The instant messenger services component detects when users are logged-on so as to provide the voicemail and email messenger services between the various users.

The notification services component offers such functionality as notifications (either internal or external) based on a timer or on external events such as fluctuating financial data. For example, users can request that they receive a telephone wake-up call every day at 5 am. Similarly, backend services and platform elements can request that they receive notification to perform actions at pre-determined times. For example, the user profile management service component can request that it receive an instruction every 6 months to communicate with users to update their address and phone information.

The alarm services component affords a straightforward way for system components to report a wide variety of alarms, allowing for notification (via SNMP, telephone, electronic mail, pager, facsimile, SMS, MMS, WAP, push, etc.) based on alarm conditions. The alarm services also allow for alarm management (e.g., assignment, condition, tracking, etc.) and integration with trouble-shooting/identifying, and/or user help systems. Finally, the alarm services component also allows for integration of alarms into any associated environment, such as the physical premises of a user.

A fourth group of backend services according to the embodiment of FIG. 2, demographics-related services 218, can be considered to include such services as location services, advertising services, transaction-related services, and billing services.

As its foundational offering, the location services provides the geographic location of a user. In an embodiment directed to locating a cellphone caller, location services sends a request to the wireless carrier or to a location network service provider (e.g., U.S. Wireless, TimesThree, etc.). In this example, the network provider responds with the geographic location (accurate within 75 meters) of the cellphone caller.

Advertising services administers the insertion of advertisements within each content delivery package or call. The advertising services component can deliver targeted advertisements based on any known data associated with the target (demographics information, user profile information, location, etc.). Also provided are interfaces to external advertising services such as Wyndwire.

The transactions services component provides transaction infrastructure such as shopping cart, tax and shipping calculations, etc.; this component also interfaces to external payment systems. The billing services component provides billing features/infrastructure such as capturing and processing billable events, rating functionality, and interfaces to external billing systems. Also included, within the services layer or elsewhere, is support for external billing engines, including integration of current technologies from Nuance, Oracle, Cisco, Natural Microsystems, and Sun Microsystems.

A final component of the backend services is other services 220. Other services 220 can include such things as a third party services adapter, which can be used to implement some of the embodiments discussed below, that enables third parties to develop and use their own external services. For example, if a customer wants to leverage a proprietary system, the third party service adapter can enable it as a service that is available to other applications.

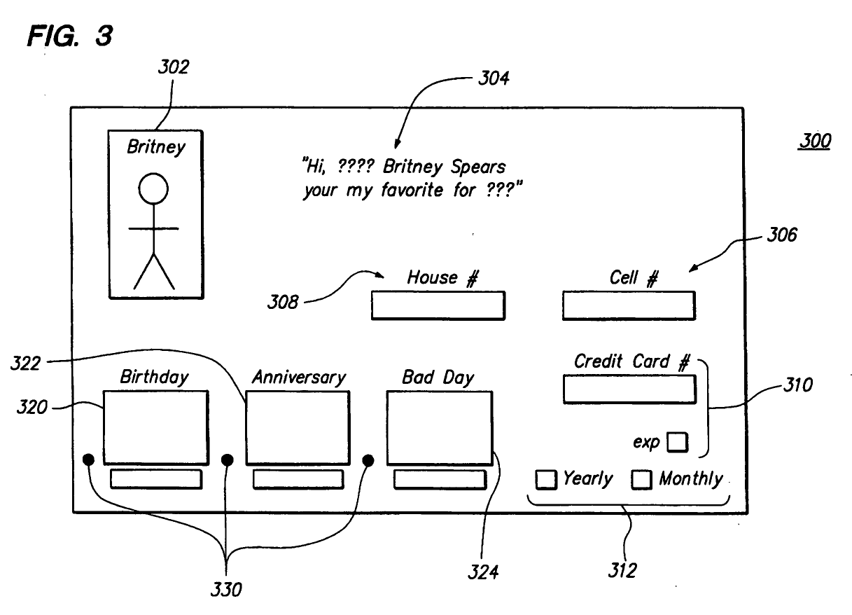

By way of detailed example, a third party services adapter could be utilized to implement the embodiment shown in FIG. 3. A graphical user interface (“GUI”) showing an enrollment window related to subscription service, according to embodiments of the present invention, is illustrated in FIG. 3. As background, a user might learn of the website via the television or via another website, Internet provider, or the like, or through a link, advertisement, or other means. At an initial screen (not shown) of the subscription website there would be a list of various entities of interest (e.g., musical artists), according to embodiments of the present invention. The user can select an entity or entities of interest, and subscribe to hear voice messages or live voice calls. In a third party services adapter implementation, a user may access a dedicated web property (driven, for example, through a broadcast partner who is sharing in the revenue) for purposes of enrolling in the relevant phone subscription service.

In the enrollment process illustrated in the embodiment of FIG. 3, the user enters information into the subscription GUI 300. In this exemplary embodiment, the subscription service pertains to a certain individual 302, who may also be represented by some textual information 304 which the individual has said or is related to the individual. As this subscription service pertains to the delivery of a voice message to a user's telephone, the user is required to enter phone numbers into the proper fields. The user can use their mobile phone number 306, their home phone number 308, work phone number, and/or any phone number capable of receiving the content to be delivered (here, a simple voice message). The user also enters their credit/debit card information 310 and/or other billing information, and subscribes to the desired term of service 312 (e.g., a yearly, monthly or other length service). In alternate embodiments, users can pay for one message at a time or for discrete numbers of messages, and the subscription programs can differ for various entities of interest.

According to the embodiment of FIG. 3, subscribing to the service allows the user to receive a certain number of calls from an entity of interest chosen by the user. The entity of interest may be a musical artist, actor, celebrity chef, sports figure, race-car driver, model, other famous person, and/or any other real or imaginary figure that may be represented via received content. As seen in the figure, the user may also enter special dates into fields provided for such events as birthdays 320, anniversaries 322, and/or bad days 324. In response to the dates entered, special messages pertaining to that particular day can be broadcast from the entity of interest to the user at the phone number(s) entered. In the illustrated embodiment, the subscription GUI 300 enables the user to choose to send a greeting from an entity of interest, to a recipient (e.g., a birthday greeting, anniversary greeting, Mother's Day greeting, recipe, advice, etc.). Other messages can be sent to a recipient (e.g., friend, etc.) as well (e.g., sympathy messages, messages that attempt to cheer someone up who had a bad day, etc.). The recipient can be the user or someone else. The subscription GUI 300 can also include additional buttons 330, according to this embodiment, that allow the user to preview the audio or voice data (e.g., in WAV format) that is to be transmitted on that day. In such preferred embodiment, the service is especially well-suited to act as a voice-based fan club.

In operation, once a user decides to subscribe to receive messages from a given entity of interest, the user first selects the entity (or entities) of interest. The user then signs up with his or her phone number or numbers (i.e., enters his or her phone number or numbers). In one embodiment, the user can receive a discount for signing up for more than one entity of interest. In one example, the user is informed that a message/call from the first entity of interest will be delivered on the 15^{th} of each month between 5:00 P.M. and 7:00 P.M. The subscribing user can choose to intercept that call live if he or she wishes. The call may comprise any suitable information, such as the entity of interest speaking about what is new in his or her life, upcoming concerts, upcoming movies, upcoming albums, new merchandising opportunities, exclusive offers, public relations, excerpts from new song and/or album, upcoming releases, new recipes, significant others, life in general, the entity's side of a story, advice, etc. At the beginning, end or anywhere in between the message, a message from a sponsor can be included. It is contemplated that the entity of interest can be the one speaking the message from the sponsor, but this need not be the case. So one revenue stream can flow from the users to at least one of the entities of interest, the owner of the present invention, and the web service providers. Another revenue stream can flow from the sponsors to at least one of the entities of interest, the owner of the present invention, and the web service providers.

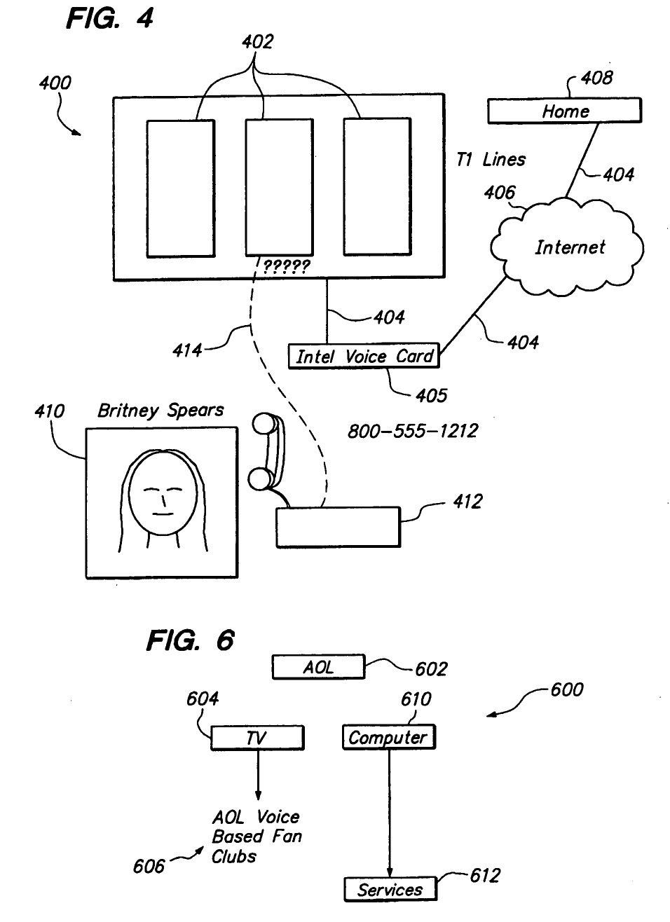

FIG. 4 illustrates a block diagram of a content delivery system 400 associated with the above-described subscription service, according to one embodiment of the present invention. This exemplary content delivery system 400 is comprised of a server farm 402, transmission lines 404, a speech/voice component 405, a network 406 (such as the internet), and the recipient 408. The speech/voice component 405 can be an internal or external speech recognition element (as with the embodiment of FIG. 2), a voice conversion card (such as an Intel VoiceCard), and/or any other hardware or software element associated with the creation, modification, administration or delivery of speech/voice content or data related to (currently, previously, or soon to be) speech/voice data. By use of such speech/voice components 205, messages can be ‘played’ through the computer and/or appear on the computer. In a preferred embodiment, a recipient or user at his or her home communicates, via the Internet, with one or more servers at the server farm 402.

In some embodiments, the content delivery system 400 also requires that the entity of interest 410 have a device 412 to record or capture the desired content, as well as a mechanism or means to transmit 414 the content to the server farm 402. In a preferred embodiment, the server farm 402 includes robust connectivity (e.g., on the order of 100s of T1 lines, etc.), and has the capacity to deliver millions of voice or other content messages per day. Such capture technology can be one of the techniques used to acquire unique voice ringtones for subscribers; users would then be able to download, for example, voice ringtones associated with a user's favorite entity of interest.

According to another preferred embodiment, this system of servers 402 and transmission lines 404 (e.g., T1 lines, etc.) is used in conjunction with a predictive dialer. Messages are created and recorded by the entities of interest 410. In a preferred embodiment, the entity of interest speaks into a phone, and their voice is recorded digitally at a receiving center associated with the server farm 402. The message can be edited, filtered, censored, and/or otherwise manipulated. Once uploaded to the server farm 402, the messages are sent to the individual users/recipients at their respective phone numbers and/or computers. For example, the recorded (or live) messages are sent to the phone numbers 306, 308 that were implemented within a field of web properties by the users or fans (see FIG. 3). Additionally, each entity of interest can have a frequency with which messages will be delivered to subscribing users. The desired message can then be transmitted and/or deposited with the users' voicemail centers or answering machines. The users can also listen to the messages while the messages are being transmitted from the server or servers (i.e., intercept live messages). In a further embodiment, the users can also intercept live calls or callers and tap into any variety of streaming content.

In a further embodiment, one or more messages from the entity of interest can be invitations to meet in person backstage, etc. These invitations can be prerecorded or a live call. Methods of informing the user in advance that they might win something like an invitation, and/or may be able to speak live with the entity of interest, are used to entice the user to subscribe. In another embodiment, instead of a fan club as described herein, users can join a book club. The users can receive messages from entities of interest (e.g., authors, etc.) informing them of new releases from authors/publishing companies, and/or other promotional or related products or services.

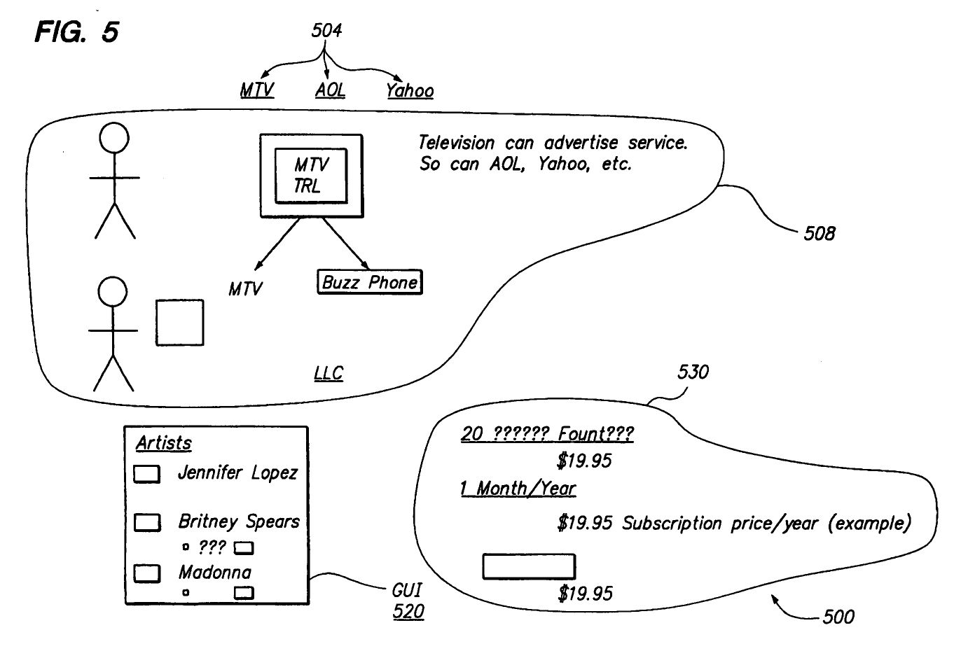

Implementations of exemplary revenue generating embodiments are illustrated in FIG. 5, according to one or more embodiments of the present invention. As seen in the figure, revenue models 500 can include advertising partners 504, advertising schemata 508, a representative entity of interest GUI 520 pricing scheme selection fields 530 that can be related to the entity of interest GUI 520. In general, the inventive services can be advertised on a website or television with a picture of the entity of interest and/or a printed or recorded message. In one revenue generating scheme according to the embodiments of FIG. 5, a web provider, sponsor and/or other advertiser 504 of the service can receive a percentage of every user subscription. In another embodiment, there is no charge to the user and the service is completely subsidized by a sponsor(s).

In one exemplary embodiment best illustrated in association with FIGS. 5 and 6, a user logs on to America Online (AOL) and clicks on a link for the disclosed content service. As shown in FIG. 5, the user is taken to an entity of interest GUI 520 where he or she can search for their favorite celebrity. The user then selects an entity of interest; for example, Britney Spears. The user then chooses from the pricing scheme selection fields 530, to receive a message from Britney once a month for a yearly fee of $19.95. The service indicates that the message is to be sent on the 1^{st} of each month between 6:00 P.M. and 7:00 P.M. In such embodiments, the user will also encounter a GUI where he or she supplies her desired phone number and credit card information, although the order of any of this functionality is not important.

On the first of the next month, if the user can check his or her voicemail after 7:00 P.M., the user can hear the two-minute long message from Britney that has been delivered. In exemplary messages, Britney can talk about her current boyfriend, her album that will released next, her hobbies, her family, and she could also thank her loyal fans. A 10 second preview of one of the songs could be played as well. The message may also begin or end with a message from a sponsor, or such message may be integrated into the message somehow.

In another embodiment, Britney asks the user to press “1” to order concert tickets now, “2” to order motion picture tickets, “3” to be connected to compact disc sales, “4” to register for a special event, etc. The user is then connected to an appropriate call center (automated or live) where he or she can place an order, etc. A percentage of the revenue flows to the service and another percentage to the partner(s) of the service.

A block diagram of an exemplary content delivery service is illustrated in FIG. 6, according to embodiments of the present invention. The content delivery scheme 600 shown in the figure depicts a delivery model stemming from American On-line (AOL) 602. AOL content-related services can be effectuated via television broadcast 604 and may be thereby associated with functionality such as AOL voice-based fan clubs 606, or the AOL content-related services may be disseminated via traditional computer systems 610.

In a presently preferred embodiment, this latter, computer system 610 scheme (related to the platform illustrated in FIG. 2) is linked to interactive content-providing services 612, such as those for mobile or hand-held devices. These content providing services can include games for handheld devices including Pocket PC, Palm, mobile phones platforms including J2ME and Qualcomm's BREW, Symbian devices, and Nintendo's Game Boy Advance. Improved popularity is achieved by association with user-desired entities, features or demographic information, including brand-recognized athletes, artists, and celebrities that are created into game characters, for example, as well as by similar branding-related attributes that can be expanded into other forms of entertainment. For example, in the above “games” embodiment, original games can be created, and/or created by working with licensed properties and providing original titles via various portal arrangements. This game embodiment can also include the creation of game engines for various mobile platforms that are available to be licensed to outside developers. A foundation of technology and tools for the development of handheld games translates well across the landscape of mobile devices, and use of such technology provides the advantage of significantly shortening standard development cycles.

For the various embodiments discussed throughout, and especially those associated with the discussion of FIGS. 3 through 6 herein, some of the significant deployment media and unified infrastructure is set forth as follows. By way of example, according to a preferred embodiment, the exemplary system set forth below can provide human understandable meta data (e.g., cost of delivery, content rating such as “R-rated” information, length of message, etc.) to the user, and the user can choose to agree to and accept those meta data in a variety of ways (e.g., SMS, MMS, web site, etc.). In this specific embodiment, for example, provision of the ability to accept the meta data in a SMS or MMS manner is crucial to successfully offering mobile content marketed toward young audiences. Relevant explanatory and examples of desired services for such SMS and MMS functionality is set forth below.

SMS stands for “Short Message Service.” It's part of the GSM standards which allows messages of up to 160 characters to be sent between terminals (typically, but not always, cellphone handsets) on a GSM network (see U.S. Pat. No. 6,571,103, hereby incorporated by reference). Most of the time it's used to send straight text messages between individuals, tapped out on the keypads of phones. Typically vendor-specific extensions to SMS can also be used to send data: for over-the-air delivery of mobile phone settings (e.g. “activate the icon on the handset display to let the handset owner know he has a voicemail message waiting for him”), address book entries, and so on. SMS's strength is that it's ubiquitous, although it is data-restrictive (160 characters of text isn't that great). In Europe, you can't buy a handset which doesn't support sending and receiving messages, and mobile network operators have enabled pretty reliable delivery between each other. SMS is essentially short text messages that are routed through inter-operaable telecommunication servers (e.g. SMS Center) and pushed to target phones. More informally, SMS might be called instant messages sent to mobile phones.

MMS, which stands for Multimedia Messaging Service, is a different type of data delivery. Although the end-user experience of MMS (and its acronym) suggests similarity to SMS, it is a different service (it's based on various WAP standards, actually, though network operators are keen not to associate themselves with WAP, which has been wrongly perceived as a failed experiment). MMS allows small “slideshows” of multimedia data; basically, data packets or streams (containing images, audio, text, video, and so on) are assembled on a mobile phone handset and submitted for delivery to a destination handset. The typical use for this is sending an annotated photo, and as a consequence, they're referring to MMS in their publicity as “picture messaging”, but it can do more than that. Thus, MMS might be referred to as instant messages with attachments (e.g pictures), or maybe “advanced-SMS-messages” with bootstrap instructions on how to automatically download attachments from the Internet.

In a representative example using both of these technologies (as might be associated with FIG. 4), a user might send a SMS message to a specific phone number with a code word such as “Order Britney 2003 06.” The server then replies with a confirmation: “Do you want to order Britney 2003 06? ID-1234567.” The user could answer: “Yes, ID-1234567”; next, the server makes the picture available as a MMS message, and sends out a MMS notification to the user. The user then decides whether he or she wants to receive the MMS message (based on its size, etc.). Finally, if the user downloads the MMS data, the server charges the user's phone number. This embodiment also allows for payment of such minor, discrete services anywhere without the need to pick up the phone; the above is a good example of the single integrated “gesture” functionality of the present invention, effecting content or service delivery or other functionality by means of a tightly related flow of movements/actions associated with the client, user or device (e.g., a concise sequence done from one discrete data input prompt).

The system of this embodiment can be characterized as an aggregation system providing a unified infrastructure over current technology methods for deploying media. This aggregation system uses subscription method for audio messages through both a predictive dialing system and with text messages and pictures over SMS and MMS. It is a two-way aggregation system offering consumers two ways to sign up for pictures and voice. In addition, users can use voice (saying picture “Britney”) and can send MMS message to phone. Furthermore, consumers can request content and have that dynamically deployed to the phone; however, the content would be sent first in a message indicating the size, cost or other prohibitive data/meta data of the content to the user. The consumer would then decide if he wants to purchase the content. A large file, for instance, could cost $100 over the airwaves. This is the difference between the internet and mobile—airtime costs money to deliver content. This two way type of functionality is critical to allowing consumers to understand the cost of the purchase before they commit to it. The system must have feedback built in (important before downloading the whole thing), and this type of feedback system can be machine specific. In essence, much value of this framework is that it is customized to demands of consumers.

In the foregoing, a system and method has been described for providing content or content-related services/functionality. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense. Thus, with regard to the claims appended to this application, the full range of scope afforded by the language of these claims is not to be limited by any of the embodiments set forth above.

What is claimed is:

1. A method of delivering content comprising:
engaging a user of a content subscription service;
receiving input from the user that identifies an entity from which content is desired;
generating content created by the identified entity, and
delivering the content to a recipient.

2. The method of claim 1, wherein the content is delivered in a format suitable for transmission by a short message service (SMS) system.

3. The method of claim 1, wherein the generated content includes data used to derive polyphonic ring tones, which are delivered to the ringer of the recipients phone.

4. The method of claim 1, wherein the input received from the user is transmitted over a computer network.

5. The method of claim 4, wherein the computer network is the World Wide Web and the input is entered by the user at a network web site.

6. The method of claim 1, further comprising:
accepting a subscription fee from the user, the subscription fee corresponding to the identified entity.

7. The method of claim 6, wherein the subscription fee is paid by entering the user's credit card information.

8. The method of claim 6, wherein the subscription fee is paid by providing previously arranged account information.

9. The method of claim 8, wherein the previously arranged account information is payment authorization information associated with an associated internet service provider's account.

10. The method of claim 8, wherein the associated internet service provider's account is the user's account.

11. The method of claim 8, wherein the associated internet service provider's account is an account associated with a person responsible for the user.

12. The method of claim 1, wherein the content subscription service is a multimedia messaging service (MMS).

13. The method of claim 12, wherein the content is comprised of interactive data exchange, used for purposes of recipient entertainment, that integrates the identified entity or information associated with the identified entity therewith.

14. The method of claim 1, wherein the content is comprised of interactive data exchange, used for purposes of recipient entertainment, that integrates the identified entity or information associated with the identified entity therewith.

15. A method of delivering content comprising:
engaging a user of a content subscription service;
receiving input from the user that identifies an entity from which content is desired;
generating content created by the identified entity; and
delivering the content to the user via MMS protocol.

16. The method of claim 15, wherein the content includes a voice message that is delivered to a user's phone.

17. The method of claim 16, wherein the voice message is composed by the identified entity.

18. The method of claim 16, wherein the voice message is related to the identified entity.

19. The method of claim 15, wherein the content includes a voice message that is delivered to a user's message storage media.

20. A voice subscription service method, comprising:
selecting an entity of interest;
creating a voice message, the voice message created by the entity of interest; and
providing the voice message to a recipient.

21. The method of claim 20, further comprising:
accepting a subscription fee from a user, the subscription fee corresponding to the entity of interest.

22. A communications network having a data store for storing content and a client device coupled to the network, wherein the improvement comprises a subscription access module coupled between the client device and the data store, wherein upon a request by the client device for selected content from the data store, if authorized by the subscription access module, the selected content is designated for transmission to the client device.

23. A communications network as in claim 22, wherein the content is formatted as an audio message.

24. A communications network as in claim 22, wherein the content is formatted as a text message.

25. The system of claim 24, wherein the content is a mobile gaming application.

26. A communications network as in claim 24, wherein the content is transmitted via SMS protocol.

27. A communications network as in claim 24, wherein the content is transmitted via MMS protocol.

28. A communications network as in claim 22, wherein the selected content is designated for transmission at a selected time.

29. A content subscription system for a communications network, comprising:
a data store coupled to the network and having content stored therein, wherein access to the content is controlled by an access component; and
a client device coupled to the network;
wherein upon request by the client device for selected content, if the access component authorizes access, then the content is retrieved from the data store and transmitted to the client device.

30. The system of claim 29, further including an interpreter that translates content from one format to another format.

31. The system of claim 30, wherein the interpreter translates requests by the client device.

32. The system of claim 30, wherein the interpreter translates selected content for transmission.

33. The system of claim 29, wherein the client device is granted access to the data store by obtaining a pre-defined subscription.

34. The system of claim 29, wherein the content is a mobile gaming application.

35. The system of claim 30, wherein the interpreter translates text to speech and speech to text as necessary.
